(19) United States
(12) Patent Application Publication
(10) Pub. No.: US 2022/0101353 A1
(43) Pub. Date: Mar. 31, 2022

(54) INFORMATION PROCESSING DEVICE, GUIDANCE SYSTEM, AND GUIDANCE METHOD

(71) Applicant: Toyota Jidosha Kabushiki Kaisha, Toyota-shi Aichi-ken (JP)

(72) Inventors: Kotaro Okabe, Ichikawa-shi Chiba-ken (JP); Tomo Sasaki, Toyota-shi Aichi-ken (JP); Koichi Suzuki, Miyoshi-shi Aichi-ken (JP); Genshi Kuno, Kasugai-shi Aichi-ken (JP); Koichi Hirano, Toyota-shi Aichi-ken (JP); Makoto Yamazaki, Nagoya-shi Aichi-ken (JP)

(73) Assignee: Toyota Jidosha Kabushiki Kaisha, Toyota-shi Aichi-ken (JP)

(21) Appl. No.: 17/402,949

(22) Filed: Aug. 16, 2021

(30) Foreign Application Priority Data
Sep. 29, 2020 (JP) 2020-164155

(51) Int. Cl. G06Q 30/02; G06Q 10/02

(52) U.S. Cl. CPC G06Q 30/0202; G06Q 30/0201; G06Q 30/0282; G06Q 30/0281; G06Q 10/02

(57) ABSTRACT

An information processing device includes a control unit. The control unit of the information processing device acquires a predicted staying time in which a user is predicted to stay in a store. The control unit of the information processing device determines a place to which the user is guided out of places of the store based on a result of comparison between the predicted staying time and a reference staying time.

### CROSS-REFERENCE TO RELATED APPLICATION

This application claims priority to Japanese Patent Application No. 2020-164155 filed on Sep. 29, 2020, incorporated herein by reference in its entirety.

### BACKGROUND

### 1. Technical Field

The present disclosure relates to an information processing device, a guidance system, and a guidance method.

### 2. Description of Related Art

In the related art, a waiting time management device that is used in stores such as restaurants or pubs and that predicts a time at which an occupied place becomes empty for each place is known (for example, see Japanese Unexamined Patent Application Publication No. 2016-122355 (JP 2016-122355 A)).

### SUMMARY

There is demand for techniques of guiding customers to places in a store. By guiding visitors to places in a store, it is possible to improve occupancy conditions of the store.

The disclosure provides an information processing device, a guidance system, and a guidance method that can improve occupancy conditions of a store.

An information processing device according to the disclosure includes a control unit configured to acquire a predicted staying time in which a user is predicted to stay in a store and to determine a place to which the user is guided out of places of the store based on a result of comparison between the predicted staying time and a reference staying time.

A guidance method according to the disclosure includes: causing an information processing device to acquire a predicted staying time in which a user is predicted to stay in a store; and causing the information processing device to determine a place to which the user is guided out of places of the store based on a result of comparison between the predicted staying time and a reference staying time.

According to the disclosure, it is possible to improve occupancy conditions of a store.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a guidance system according to an embodiment of the present disclosure;

FIG. 2 is a block diagram illustrating a detailed configuration of the guidance system illustrated in FIG. 1;

FIG. 3 is a sequence diagram illustrating an example of a flow of operations which are performed by the guidance system illustrated in FIG. 1; and

FIG. 4 is a flowchart illustrating an example of a flow of operations which are performed by a server illustrated in FIG. 1.

### DETAILED DESCRIPTION

Hereinafter, an embodiment of the disclosure will be described with reference to the accompanying drawings. In the following description with reference to the drawings, the same elements will be referred to by the same reference signs.

### Configuration of Guidance System

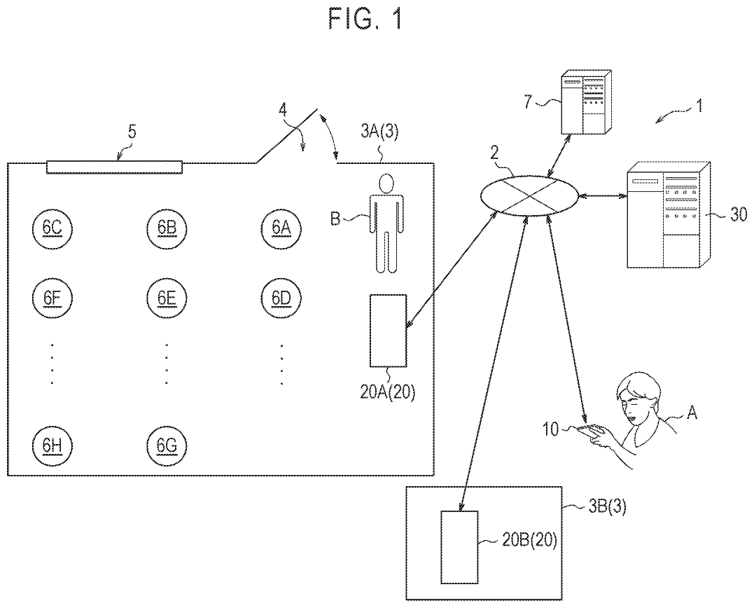

As illustrated in FIG. 1, a guidance system 1 according to an embodiment of the disclosure includes a terminal device 10, terminal devices 20A and 20B, and a server 30 (an information processing device). The terminal device 20A can be used in a store 3A. The terminal device 20B can be used in a store 3B.

In the following description, the terminal device 20A and the terminal device 20B are referred to as “terminal devices 20” together when they are not particularly distinguished. A guidance system 1 including two terminal devices 20 is illustrated in FIG. 1. Here, the guidance system 1 can include at least one terminal device 20.

The terminal device 10, the terminal device 20, and the server 30 can communicate with each other via a network 2. The network 2 may be an arbitrary network including a mobile communication network and the Internet.

In the following description, the store 3A and the store 3B are referred to as “stores 3” together when they are not particularly distinguished.

The stores 3 are, for example, stores such as restaurants. The store 3B is a store which is different from the store 3A. The store 3A and the store 3B may be restaurants that serve the same genre of dishes. The store 3A and the store 3B may be the same brand of restaurants.

The store 3A includes a doorway 4. The store 3A may include a window 5. A customer who visits the store 3A can enter the store 3A via the doorway 4 which is an entrance.

The store 3A may include an arbitrary number of places. In this embodiment, the store 3A includes places 6A, 6B, 6C, 6D, 6E, 6F, 6G, and 6H. The places 6A to 6H are a part of the places of the store 3A. The places 6A to 6C are located closer to the doorway 4 or the window 5 than the other places of the store 3A. That is, distances between the places 6A to 6C and the doorway 4 or the window 5 are shorter than distances between the other places of the store 3A and the doorway 4 or the window 5. The places 6G and 6H are located farther from the doorway 4 or the window 5 than the other places of the store 3A. That is, distances between the places 6G and 6H and the doorway 4 or the window 5 are longer than distances between the other places of the store 3A and the doorway 4 or the window 5.

For example, when a visitor of the store 3A has not made a reservation for the store 3A, the visitor may ascertain the conditions of the store 3A before entering the store 3A. In this case, the visitor can ascertain the conditions of the store 3A and determine whether to enter the store 3A or to stop entering the store 3A. The visitor can ascertain the conditions of the store 3A by seeing the inside of the store 3A from the doorway 4 or the window 5. The places 6A to 6C are located close to the doorway 4 or the window 5, and thus there is a high likelihood that a visitor will see the places 6A to 6C out of the places of the store 3A when the visitor sees the inside of the store 3A from the doorway 4 or the window 5. Accordingly, a visitor who visits the store 3A can determine the conditions of the store 3A depending on whether the places 6A to 6C are occupied.

For example, when the popularity of the store 3A is high, a visitor of the store 3A may wonder whether the store 3A is crowded before entering the store 3A. One reason that a visitor wonders whether the store 3A is crowded is that a waiting time until an available place is empty can be longer when the store 3A is crowded than when the store 3A is not crowded. A visitor can determine that the store 3A is in a crowded state when the places 6A to 6C are occupied. When it is determined that the store 3A is in the crowded state, the visitor of the store 3A can determine to stop entering the store 3A, for example, even when the places 6G and 6H are empty. On the other hand, when the places 6A to 6C are empty, the visitor can determine that the store 3A is not in the crowded state. When it is determined that the store 3A is not in the crowded state, the visitor of the store 3A can determine that the visitor enters the store 3A, for example, even when all the places 6D to 6H are occupied.

For example, when the popularity of the store 3A is low, a visitor of the store 3A may wonder whether the store 3A is prosperous before entering the store 3A. When the places 6A to 6C are occupied, the visitor may determine that the store 3A is prosperous. When it is determined that the store 3A is prosperous, the visitor of the store 3A can determine that the visitor enters the store 3A, for example, even when all the places 6D to 6H are empty. On the other hand, when the places 6A to 6C are empty, the visitor may determine that the store 3A is not prosperous. When it is determined that the store 3A is not prosperous, the visitor of the store 3A can determine to stop entering the store 3A, for example, even when all the places 6D to 6H are occupied.

The terminal device 10 can be carried by a user A. The user A can make a reservation for the store 3A by operating the terminal device 10. The user A can visit the store 3A after the reservation for the store 3A has been confirmed. The terminal device 10 may be an arbitrary device as long as it can access the network 2. The terminal device 10 may be, for example, a mobile phone, a smartphone, a tablet, or a personal computer (PC).

The terminal device 20A is provided, for example, in the store 3A. The terminal device 20B is provided, for example, in the store 3B. The terminal device 20 may be an arbitrary device as long as it can access the network 2. The terminal device 20 may be, for example, a mobile phone, a smartphone, a tablet, or a personal computer (PC).

For example, when a reservation of a user for the store 3A is confirmed as will be described later, the server 30 can determine a place to which the user A is guided out of the places of the store 3A. The place to which the user A is guided and which is determined by the server 30 is output from the terminal device 20A. An employee B of the store 3A can recommend the place output from the terminal device 20A to the user A when the user A visits the store 3A. With this configuration, for example, a likelihood that a user who has not made a reservation for the store 3A will stop entering the store 3A can be decreased as will be described later.

The server 30 may provide a service of reserving a store 3 or the like. The server 30 may be a dedicated computer configured to serve as a server, a general-purpose personal computer, a cloud computing system, or the like.

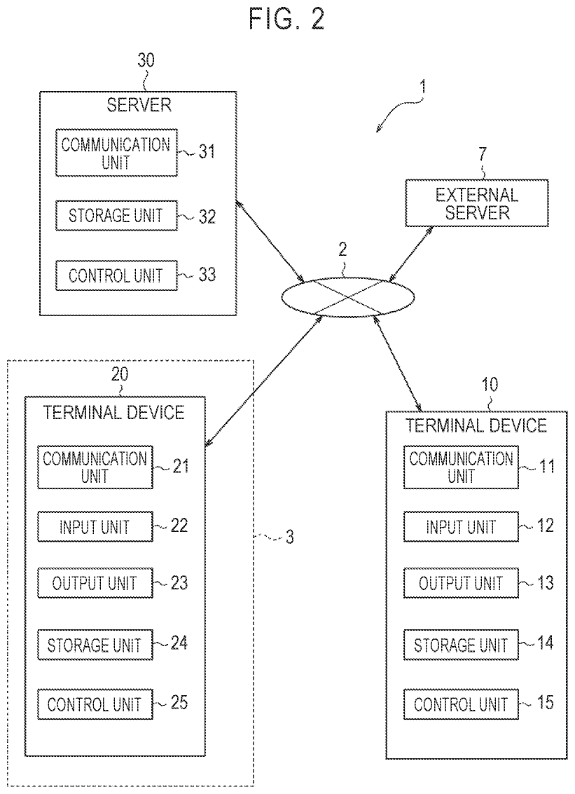

As illustrated in FIG. 2, the terminal device 10 includes a communication unit 11, an input unit 12, an output unit 13, a storage unit 14, and a control unit 15.

The communication unit 11 includes at least one communication module that can access the network 2. The communication module is, for example, a communication module corresponding to a mobile communication standard such as Long Term Evolution (LTE), 4th generation (4G), or 5th generation (5G). The communication unit 11 may further include a communication module corresponding to short-range radio communication. The short-range radio communication is, for example, near-field communication (NFC) or Bluetooth (registered trademark).

The input unit 12 can receive an input from a user. The input unit 12 includes, for example, at least one input interface that can receive an input from a user. The input interface may be physical keys, capacitance keys, a pointing device, a touch screen that is integrally incorporated into a display, a microphone, or the like.

The output unit 13 can output data. The output unit 13 includes at least one output interface that can output data. The output interface may be a display, a speaker, or the like. The display may be a liquid crystal display (LCD), an organic electroluminescence (EL) display, or the like.

The storage unit 14 includes at least one semiconductor memory, at least one magnetic memory, at least one optical memory, or a combination of at least two types thereof. Examples of the semiconductor memory include a random access memory (RAM) or a read only memory (ROM). Examples of the RAM include a static random access memory (SRAM) and a dynamic random access memory (DRAM). Examples of the ROM include an electrically erasable programmable read only memory (EEPROM). The storage unit 14 may serve as a main storage device, an auxiliary storage device, or a cache storage device. The storage unit 14 stores data that is used for an operation of the terminal device 10 and data that is acquired from the operation of the terminal device 10.

The control unit 15 includes at least one processor, at least one dedicated circuit, or a combination thereof. The processor is a general-purpose processor such as a central processing unit (CPU) or a graphics processing unit (GPU) or a dedicated processor specialized in a specific process. Examples of the dedicated circuit include a field-programmable gate array (FPGA) and an application specific integrated circuit (ASIC). The control unit 15 can control the constituents of the terminal device 10 and perform processes associated with the operation of the terminal device 10.

The functions of the terminal device 10 can be realized by causing a processor corresponding to the control unit 15 to execute a first terminal program according to this embodiment. That is, the functions of the terminal device 10 can be realized by software. The first terminal program can cause a computer to serve as the terminal device 10 by causing the computer to execute the operation of the terminal device 10. That is, the computer can serve as the terminal device 10 by performing the operation of the terminal device 10 in accordance with the first terminal program.

In the disclosure, a “program” can be stored in a computer-readable non-transitory recording medium. The computer-readable non-transitory recording medium is, for example, a magnetic recording device, an optical disc, a magneto-optical recording medium, or a ROM. The program is distributed, for example, by selling, transferring, or lending a portable recording medium such as a digital versatile disc (DVD) or a compact-disc read only memory (CD-ROM) having the program recorded thereon. The program may be stored in a storage of a server. The program stored in the storage of the server may be distributed by transmitting the program to another computer. The program may be provided as a program product.

In the disclosure, for example, a “computer” can temporarily store a program recorded on a portable recording medium or a program transmitted from a server in a main storage device. Then, the computer can read the program stored in the main storage device using a processor and cause the processor to perform processing based on the read program. The computer may directly read a program from the portable recording medium and perform processing based on the program. When the program is transmitted from the server to the computer, the computer may sequentially perform processing based on the received program. The processing may be performed by a so-called application service provider (ASP) type service in which transmission of a program from the server to the computer is not performed and the function is realized by only execution instruction and result acquisition. The program can include information which is provided for processing in a computer and which is based on a program. For example, data which is not a direct command to a computer but has characteristics for defining the processing in the computer corresponds to the “information which is based on a program.”

Some or all functions of the terminal device 10 may be realized by a dedicated circuit corresponding to the control unit 15. That is, some or all functions of the terminal device 10 may be realized by hardware.

The control unit 15 can receive an input for requesting reading of information indicating a reservation situation of the store 3A using the input unit 12. This input can be input from the input unit 12 by a user A who wants to read the information indicating the reservation situation of the store 3A. When the input is received by the input unit 12, the control unit 15 can transmit a notification for requesting the information indicating the reservation situation of the store 3A to the server 30 via the network 2 using the communication unit 11. After transmitting this notification, the control unit 15 can receive the information indicating the reservation situation of the store 3A from the server 30 via the network 2 using the communication unit 11. The control unit 15 can output the information indicating the reservation situation of the store 3A from the output unit 13. When the information indicating the reservation situation of the store 3A is output from the output unit 13, the user A can read the information indicating the reservation situation of the store 3A. The user A can ascertain an available date and time or the like for the store 3A by reading the information indicating the reservation situation of the store 3A.

The control unit 15 can receive an input for requesting a reservation for the store 3A using the input unit 12. For example, this input can be input from the input unit 12 by the user A who wants to make a reservation for the store 3A. For example, this input includes an input of identification information of the user A, an input of identification information of the store 3A, an input of the number of users who want to visit the store 3A, and an input of a date and time at which the store 3A is wanted to use. Here, the identification information of the user may be arbitrary information for identifying the user A. The identification information of the store 3 may be arbitrary information for identifying the store 3. The control unit 15 can generate request information when the input for requesting a reservation for the store 3A is received. The request information includes, for example, the identification information of the user A, the identification information of the store 3A, information of the number of users who want to visit the store 3A, and the date and time at which the store 3A is wanted to use. The control unit 15 can transmit the request information to the server 30 via the network 2 using the communication unit 11.

After transmitting the request information, the control unit 15 can receive first reservation information from the server 30 via the network 2 using the communication unit 11. The first reservation information can include a notification indicating that the reservation for the store 3A has been confirmed or the like as will be described below. When the first reservation information is received, the control unit 15 may output the first reservation information from the output unit 13. When the first reservation information is output from the output unit 13, the user A can ascertain that the reservation for the store 3A has been confirmed. Thereafter, the user A can visit the store 3A.

The control unit 15 may perform electronic payment by performing radio communication with the terminal device 20 of the store 3 by short-range radio communication. For example, the user A may pay charge for use of the store 3A by electronic payment at the time of exiting the store 3A. In this case, in the electronic payment, the control unit 15 can transmit the identification information of the user A to the terminal device 20 of the store 3 by short-range radio communication using the communication unit 11.

As illustrated in FIG. 2, the terminal device 20 includes a communication unit 21, an input unit 22, an output unit 23, a storage unit 24, and a control unit 25.

The communication unit 21 includes at least one communication module that can access the network 2. The communication module is, for example, a communication module corresponding to a wired local area network (LAN) standard, a wireless LAN standard, or the like. The communication unit 21 can access the network 2 via a wired LAN or a wireless LAN using the communication module. Similarly to the communication unit 11, the communication unit 21 may further include a communication module corresponding to short-range radio communication.

The input unit 22 can receive an input from a user. Similarly to the input unit 12, the input unit 22 includes, for example, at least one input interface that can receive an input from a user.

The output unit 23 can output data. Similarly to the output unit 13, the output unit 23 can include at least one output interface that can output data.

Similarly to the storage unit 14, the storage unit 24 includes at least one semiconductor memory, at least one magnetic memory, at least one optical memory, or a combination of at least two types thereof. The storage unit 24 may serve as a main storage device, an auxiliary storage device, or a cache storage device. The storage unit 24 stores data that is used for an operation of the terminal device 20 and data that is acquired from the operation of the terminal device 20.

Similarly to the control unit 15, the control unit 25 includes at least one processor, at least one dedicated circuit, or a combination thereof. The control unit 25 can control the constituents of the terminal device 20 and perform processes associated with the operation of the terminal device 20. The control unit 25 may have a timer function of acquiring a current time.

The functions of the terminal device 20 can be realized by causing a processor corresponding to the control unit 25 to execute a second terminal program according to this embodiment. That is, the functions of the terminal device 20 can be realized by software. The second terminal program can cause a computer to serve as the terminal device 20 by causing the computer to execute the operation of the terminal device 20. That is, the computer can serve as the terminal device 20 by performing the operation of the terminal device 20 in accordance with the second terminal program.

Some or all functions of the terminal device 20 may be realized by a dedicated circuit corresponding to the control unit 25. That is, some or all functions of the terminal device 20 may be realized by hardware.

The control unit 25 can receive second reservation information from the server 30 via the network 2 using the communication unit 21. The second reservation information includes identification information of a user who has made a reservation for the store 3 or the like as will be described later. The control unit 25 may output the second reservation information from the output unit 23. When the second reservation information is output from the output unit 23, an employee of the store 3 can ascertain the user who has made a reservation for the store 3 or the like.

The control unit 25 can receive guidance information form the server 30 via the network 2 using the communication unit 21. The guidance information includes information of a place to which the user having reserved the store 3 is guided. The guidance information may include identification information of the user having reserved the store 3 along with the information of the place to which the user having reserved the store 3 is guided. The control unit 25 may output the received guidance information from the output unit 23. When the guidance information is output from the output unit 23, an employee of the store 3 can ascertain the place to which the user is guided. The employee of the store 3 can recommend the place to the user having reserved the store 3 when the user visits the store 3. The user can occupy the place when the place is recommended by the employee.

The control unit 25 can receive an input indicating that the user has entered the store 3 along with an input of the identification information of the user using the input unit 22. These inputs are input from the input unit 22 by the employee of the store 3, for example, when the user having reserved the store 3 has entered the store 3. When these inputs are received, the control unit 25 may acquire information of a first date and time at which the user has entered the store 3 using the timer function of the control unit 25. The first date and time may be a date and time at which the user has entered the store 3. The information of the first date and time may include information of a date and information of a time at which the user entered the store 3. The control unit 25 may transmit the information of the first date and time along with the identification information of the store 3 and the identification information of the user to the server 30 via the network 2 using the communication unit 21.

The control unit 25 can receive an input indicating that the user has exited the store 3 along with the input of the identification information of the user using the input unit 22. These inputs can be input from the input unit 22 by an employee of the store 3, for example, when the user having reserved the store 3 exits the store 3. When these inputs are received, the control unit 25 may acquire information of a second date and time at which the user has exited the store 3 using the timer function of the control unit 25. The second date and time may be a date and time at which the user has exited the store 3. The information of the second date and time includes information of a date and information of a time at which the user has exited the store 3. The control unit 25 may transmit the information of the second date and time along with the identification information of the store 3 and the identification information of the user to the server 30 via the network 2 using the communication unit 21.

The control unit 25 can perform electronic payment by performing radio communication with the terminal device 10 using short-range radio communication. As described above, for example, the user A may pay charge for use of the store 3A by electronic payment at the time of exiting the store 3A. In the electronic payment, the control unit 25 can receive the identification information of the user from a terminal device of the user such as the terminal device 10 by short-range radio communication using the communication unit 21. The control unit 25 may acquire the information of the date and time at which the identification information of the user has been acquired using the timer function of the control unit 25. The control unit 25 may consider the date and time at which the identification information of the user has been acquired as the second date and time. The control unit 25 may transmit the information of the second date and time along with the identification information of the store 3 and the identification information of the user to the server 30 via the network 2 using the communication unit 21.

As illustrated in FIG. 2, the server 30 includes a communication unit 31, a storage unit 32, and a control unit 33.

Similarly to the communication unit 21, the communication unit 31 includes at least one communication module that can access the network 2. Similarly to the communication unit 21, the communication unit 31 can access the network 2 via a wired LAN or a wireless LAN using the communication module corresponding to a wired LAN standard or a wireless LAN standard.

Similarly to the storage unit 14, the storage unit 32 includes at least one semiconductor memory, at least one magnetic memory, at least one optical memory, or a combination of at least two types thereof. The storage unit 32 may serve as a main storage device, an auxiliary storage device, or a cache storage device. The storage unit 32 stores data that is used for an operation of the server 30 and data that is acquired from the operation of the server 30.

For example, the storage unit 32 stores information indicating a reservation situation of the store 3. The information indicating the reservation situation of the store 3 can be appropriately updated by causing the control unit 33 to perform a reservation receiving process which will be described later. The storage unit 32 stores, for example, information of the number of places of the store 3. The storage unit 32 stores place arrangement information of the store 3. The place arrangement information of the store 3A includes information of distances between the places of the store 3A and the doorway 4 which is an entrance or the window 5 of the store 3A.

Similarly to the control unit 15, the control unit 33 includes at least one processor, at least one dedicated circuit, or a combination thereof. The control unit 33 can control the constituents of the server 30 and perform processes associated with the operation of the server 30.

The functions of the server 30 can be realized by causing a processor corresponding to the control unit 33 to execute a processing program according to this embodiment. That is, the functions of the server 30 can be realized by software. The processing program can cause a computer to serve as the server 30 by causing the computer to execute the operation of the server 30. That is, the computer can serve as the server 30 by performing the operation of the server 30 in accordance with the processing program.

Some or all functions of the server 30 may be realized by a dedicated circuit corresponding to the control unit 33. That is, some or all functions of the server 30 may be realized by hardware.

The control unit 33 can receive the information of the first date and time along with the identification information of the store 3 and the identification information of the user from the terminal device 20 of the store 3 via the network 2 using the communication unit 31. The control unit 33 can store the information of the first date and time correlated with the identification information of the store 3 and the identification information of the user in the storage unit 32. The control unit 33 can receive the information of the second date and time along with the identification information of the store 3 and the identification information of the user from the terminal device 20 of the store 3 via the network 2 using the communication unit 31. The control unit 33 can store the information of the second date and time correlated with the identification information of the store 3 and the identification information of the user in the storage unit 32.

Process of Receiving Reservation

The control unit 33 can receive a notification for requesting the information indicating the reservation situation of the store 3A from the terminal device 10 via the network 2 using the communication unit 31. When this notification is received, the control unit 33 can acquire the information indicating the reservation situation of the store 3A from the storage unit 32. The control unit 33 can transmit the information indicating the reservation situation of the store 3A to the terminal device 10 via the network 2 using the communication unit 31.

After having transmitted the information indicating the reservation situation of the store 3A, the control unit 33 can receive request information from the terminal device 10 via the network 2 using the communication unit 31. When the request information is received, the control unit 33 can confirm the reservation of the user A. The control unit 33 confirms the reservation of the user A, for example, by updating the information indicating the reservation situation of the store 3A in the storage unit 32 based on the request information.

When the reservation of the user A for the store 3A is confirmed, the control unit 33 can generate first reservation information and second reservation information. The first reservation information includes a notification indicating that the reservation for the store 3A has been confirmed and information of the number of reserved users and the reservation date and time. The second reservation information includes the identification information of the user A who has reserved the store 3A and the information of the number of reserved users and the reservation date and time. The control unit 33 can transmit the first reservation information to the terminal device 10 via the network 2 using the communication unit 31. The control unit 33 can transmit the second reservation information to the terminal device 20A of the store 3A via the network 2 using the communication unit 31.

### Process of Acquiring Predicted Staying Time

For example, when the reservation of the user A for the store 3A is confirmed, the control unit 33 can acquire a predicted staying time in which the user A is predicted to stay in the store 3A. The control unit 33 may acquire the predicted staying time of the user A based on the information of the first date and time and the information of the second date and time. The predicted staying time of the user A can be used in a process of determining a place to which the user A is guided, which will be described later.

### Example 1

The control unit 33 may calculate the predicted staying time of the user A based on a staying time in the past of the user A in the store 3A and acquire the predicted staying time of the user A. In an example of calculating the staying time in the past of the user A, the control unit 33 may acquire the information of the first date and time and the information of the second date and time which are correlated with the identification information of the user A and the identification information of the store 3A from the storage unit 32. The control unit 33 may specify a combination of the information of the first date and time and the information of the second date and time including the information of the same date and time in the information of the first date and time and the information of the second date and time which are acquired from the storage unit 32. The control unit 33 may calculate the staying time in the past of the user A by subtracting the time of the first date and time from the time of the second date and time in the combination of the information of the first date and time and the information of the second date and time including the information of the same date and time.

For example, when the user A visited the store 3A a plurality of times in the past, the control unit 33 may calculate an average staying time in the past of the user A as the predicted staying time of the user A. When the user A visited the store 3A a plurality of times in the past, the control unit 33 can specify a plurality of combinations of the information of the first date and time and the information of the second date and time including the information of the same date and time. The control unit 33 may calculate a plurality of staying times in the past of the user A based on combinations of the information of the first date and time and the information of the second date and time including information of dates tracing back a set number of days from the date at which the reservation of the user A for the store 3A has been confirmed. The set number of days may be appropriately set based on the frequency in which menus which are provided in the store 3A are changed or the like. The control unit 33 may calculate an average staying time in the past of the user A based on a plurality of staying times in the past of the user A.

For example, when the user A visited the store 3A once in the past, the control unit 33 may calculate one staying time in the past of the user A as the predicted staying time of the user A. When the user A visited the store 3A once in the past, the control unit 33 can specify one combination of the information of the first date and time and the information of the second date and time including the information of the same date. In this case, the control unit 33 may calculate one staying time in the past of the user A based on the specified combination of the information of the first date and time and the information of the second date and time.

### Example 2

The control unit 33 may calculate the predicted staying time of the user A in the store 3A based on a staying time in the past of the user A in a store 3B different from the store 3A and acquire the predicted staying time of the user A. When the store 3A and the store 3B are restaurants that serve the same genre of dishes, the control unit 33 may calculate the predicted staying time of the user A in the store 3A based on the staying time in the past of the user A in the store 3B. When the store 3A and the store 3B are the same brand of restaurants, the control unit 33 may calculate the predicted staying time of the user A in the store 3A based on the staying time in the past of the user A in the store 3B. When the store 3A and the store 3B are restaurants that serve the same genre of dishes or when the store 3A and the store 3B are the same brand of restaurants, the menus of dishes that are served by the store 3A and menus of dishes that are served by the store 3B may be equal or similar to each other. Accordingly, even when the store 3B is a store different from the store 3A, the staying time of the user in the store 3B may be equal to the staying time of the user in the store 3A. With this configuration, it is possible to calculate the predicted staying time of the user A in the store 3A based on the staying time in the pas of the user A in the store 3B.

For example, when the user A visited the store 3B a plurality of times in the past, the control unit 33 may calculate an average staying time in the past of the user A in the store 3B as the predicted staying time of the user A in the store 3A. The control unit 33 may calculate the average staying time in the past of the user A in the store 3B in the same way as described above in Example 1.

For example, when the user A visited the store 3B once in the past, the control unit 33 may calculate one staying time in the past of the user A in the store 3B as the predicted staying time of the user A in the store 3A. The control unit 33 may calculate one staying time in the past of the user A in the store 3B in the same way as described above in Example 1.

### Process of Correcting Predicted Staying Time

The control unit 33 may appropriately correct the predicted staying time of the user A. When the predicted staying time of the user A has been corrected, the control unit 33 may use the corrected predicted staying time of the user A for the process of determining a place to which the user A is guided, which will be described later. By correcting the predicted staying time of the user A, it is possible to more accurately determine a place to which the user A is guided in the process of determining the place to which the user A is guided, which will be described later.

### Example 1

The control unit 33 may correct the predicted staying time of the user A such that the predicted staying time of the user A is longer when it is estimated the user A visits the store 3A along with another user than when it is estimated that the user A visits the store 3A alone. The control unit 33 may estimate whether the user A visits the store 3A along with another user or whether the user A visits the store 3A alone depending on the number of reserved users included in the first reservation information and the second reservation information.

When the staying time in the past of the user A in the store 3A when the user A visited the store 3A alone in the past is calculated as the predicted staying time of the user A, the control unit 33 may estimate whether the user A visits the store 3A along with another user or whether the user A visits the store 3A alone. When the staying time in the past of the user A in the store 3A when the user A visited the store 3A alone in the past is calculated and it is estimated that the user A visits the store 3A along with another user, the control unit 33 may correct the staying time in the past of the user A, that is, the predicted staying time of the user A. The control unit 33 may estimate whether the user A visited the store 3A alone in the past based on information of a date included in the information of the first date and time and the information of the second date and time used to calculate the staying time in the past of the user A, the first reservation information transmitted to the terminal device 10 in the past, and the like.

When it is estimated that the user A visits the store 3A along with another user, the control unit 33 may correct the predicted staying time of the user A by multiplying the predicted staying time of the user A by a correction factor. The correction factor may be greater than 1. The correction factor may be appropriately set experimentally or theoretically.

When the user A visits the store 3A along with another user, the user A may have a talk with the other user or the like while staying in the store 3A. When the user A visits the store 3A along with another user, the staying time of the user A in the store 3A may be longer due to a talk of the user A with the other user or the like than when the user A visits the store 3A alone. When it is estimated that the user A visits the store 3A along with another user, it is possible to more accurately calculate the predicted staying time of the user A by correcting the predicted staying time of the user A such that it is increased.

### Example 2

When it is estimated that the user A visits the store 3A along with a plurality of other users, the control unit 33 may correct the predicted staying time of the user A based on the number of other users. The control unit 33 may estimate whether the user A visits the store 3A along with a plurality of other users based on the number of reserved users included in the first reservation information and the second reservation information. The control unit 33 may estimate the number of other users who visit the store 3A along with the user A based on the number of reserved users included in the first reservation information and the second reservation information. The control unit 33 may correct the predicted staying time of the user A such that the predicted staying time of the user A becomes longer as the number of other users who visit the store 3A along with the user A becomes larger.

When it is estimated that the user A visits the store 3A along with a plurality of other users, the control unit 33 may correct the predicted staying time of the user A by multiplying the predicted staying time of the user A by a correction factor based on the number of users. The correction factor may be set to increase as the number of other users increases. The correction factor may be appropriately set experimentally or theoretically.

When the user A visits the store 3A along with a plurality of other users, the user A may have a talk with the plurality of other users or the like while the user A stays in the store 3A. As the number of other users becomes larger, the staying time of the user A may become longer due to a talk of the user A with the plurality of other users or the like. When it is estimated that the user A visits the store 3A along with a plurality of other users, it is possible to more accurately calculate the predicted staying time of the user A by correcting the predicted staying time of the user A such that it is increased depending on the number of other users.

### Process of Acquiring Reference Staying Time

The control unit 33 can acquire a reference staying time, for example, when the reservation of the user A for the store 3A is confirmed. The reference staying time may be a time serving as an index for determining whether the staying time of a user whose a staying time is longer than the reference staying time is longer than staying times of other users. The reference staying time can be used for the process of determining a place to which the user A is guided, which will be described later.

The control unit 33 may acquire the reference staying time by calculating an average staying time of a plurality of users who visited the store 3A in the past. The control unit 33 may acquire the calculated average staying time as the reference staying time. The control unit 33 may acquire the information of the first date and time and the information of the second date and time from the storage unit 32 and calculate the average staying time of a plurality of users who visited the store 3A in the past in the same way as described above. The control unit 33 may calculate the average staying time of the plurality of users who visited the store 3A in the past based on the information of the first date and time and the information of the second date and time of dates tracing back a set number of days from the date at which the reservation of the user A for the store 3A has been confirmed. The set number of days may be appropriately set based on the frequency in which the menus of dishes that are served by the store 3A are changed or the like. In calculating the average staying time of a plurality of users, at least some of the plurality of users may be different from each other.

### Process of Acquiring Degree of Popularity

For example, when the reservation of the user A for the store 3A is confirmed, the control unit 33 can acquire a degree of popularity of the store 3A. The degree of popularity of the store 3A can be used for the process of determining a place to which the user A is guided, which will be described later.

The degree of popularity of the store 3A may be an index indicating a degree of popularity of the store 3A among general users. As the degree of popularity of the store 3A increases, the popularity of the store 3A among general users increases. The degree of popularity of the store 3A may be given as a numerical value. In this case, the numerical value of the store 3A may increase as the degree of popularity of the store 3A increases. The numerical value used as the degree of popularity may be limited by an upper limit value and a lower limit value. The degree of popularity of the store 3A may be given as an arbitrary level. For example, the degree of popularity of the store 3A may be given as three levels of “low,” “middle,” and “high.”

The control unit 33 may acquire the degree of popularity of the store 3A based on the reservation situation of the store 3A. In this case, the control unit 33 may acquire the information indicating the reservation situation of the store 3A from the storage unit 32. The control unit 33 may calculate a reservation ratio up to a date tracing back a set number of days from the date at which the reservation of the user A for the store 3A has been confirmed based on the information indicating the reservation situation of the store 3A. The set number of days may be appropriately set based on the frequency in which the menus of dishes that are served by the store 3A or the like are changed. The reservation ratio may be a ratio of the number of reserved users to the number of places in the store 3A. The control unit 33 may acquire a higher degree of popularity as the degree of popularity of the store 3A when the reservation ratio is relatively high than when the reservation ratio is relatively low.

The control unit 33 may receive information indicating a result of evaluation of the store 3A by users from an external server 7 via the network 2 using the communication unit 31. The control unit 33 may acquire the degree of popularity of the store 3A based on the information indicating result of evaluation of the store 3A by users. The external server 7 may provide contents including the results of evaluation of restaurants and the like by users. The control unit 33 may acquire a higher degree of popularity as the degree of popularity of the store 3A when the result of evaluation of the store 3A by users is relatively high than when the result of evaluation of the store 3A by users is relatively low.

### Determination Process

For example, when the reservation of the user A for the store 3A is confirmed, the control unit 33 can determine a place to which the user A is guided out of the places of the store 3A based on the result of comparison between the predicted staying time of the user A and the reference staying time. The control unit 33 can acquire the predicted staying time of the user A and the reference staying time as described above. When the place to which the user A is guided has been determined, the control unit 33 can generate guidance information. The guidance information includes information of the place to which the user A is guided. The guidance information may include the identification information of the user A along with information of the place to which the user A is guided. The control unit 33 can transmit the guidance information to the terminal device 20A of the store 3A via the network 2 using the communication unit 31.

The control unit 33 may determine the place to which the user A is guided based on the degree of popularity of the store 3A and the result of comparison between the predicted staying time of the user A and the reference staying time. The control unit 33 can acquire the degree of popularity of the store 3A as described above. An example of the process of determining the place to which the user A is guided will be described below.

The control unit 33 may determine whether the degree of popularity of the store 3A is equal to or greater than a threshold value. The threshold value may be an index for determining whether a store with a degree of popularity equal to or greater than the threshold value is more popular among general users than other stores. The threshold value may be appropriately set based on a degree of popularity indicating middle popularity. For example, when the degree of popularity is given as a numerical value, the threshold value is a value between an upper limit value and a lower limit value of the numerical value. For example, when the degree of popularity is given as three levels of “low,” “middle,” and “high,” the threshold value is the level of “middle.”

When it is determined that the degree of popularity of the store 3A is equal to or greater than the threshold value, the control unit 33 may determine whether the length of the predicted staying time of the user A is equal to or greater than the length of the reference staying time.

When it is determined that the degree of popularity of the store 3A is equal to or greater than the threshold value and it is determined that the length of the predicted staying time of the user A is equal to or greater than the length of the reference staying time, the control unit 33 may determine that the user A is preferentially guided to a place with low visibility from the outside of the store 3A out of the places of the store 3A. The control unit 33 may estimate that a place in the store 3A has lower visibility from the outside of the store 3A as a distance from the doorway 4 which is an entrance of the store 3A or the window 5 becomes greater. The control unit 33 can estimate that the places 6G and 6H out of the places of the store 3A have low visibility from the outside of the store 3A with reference to the place arrangement information of the store 3A in the storage unit 32. In this case, the control unit 33 can determine that the user A is preferentially guided to the places 6G and 6H. The control unit 33 can generate guidance information including information of the places 6G and 6H to which the user A is determined to be preferentially guided and the identification information of the user A. The control unit 33 can transmit the generated guidance information to the terminal device 20A of the store 3A.

In this way, when the degree of popularity of the store 3A is equal to or greater than the threshold value and thus the store 3A is estimated to be popular and when the length of the predicted staying time of the user A is equal to or greater than the length of the reference staying time, the guidance information including the information of the places 6G and 6H can be transmitted to the terminal device 20A of the store 3A. In the terminal device 20A, the control unit 25 can output the guidance information from the output unit 23. By outputting the guidance information from the output unit 23, an employee B can recommend the place 6G or the place 6H to the user A when the user A visits the store 3A. When the employee B recommends the place 6G or the place 6H to the user A, the user A can sit in the place 6G or the place 6H. Here, when the degree of popularity of the store 3A is high, a user who has not made a reservation may ascertain whether the store 3A is crowded by seeing the inside of the store 3A through the doorway 4 or the window 5 before entering the store 3A. When the user A with a long predicted staying time sits in the place 6G or the place 6H, a likelihood that the user A who is a customer is sitting in the places 6A to 6C when a user who has not made a reservation ascertains the inside of the store 3A can decrease. When the likelihood that a customer is sitting in the places 6A to 6C decreases, a likelihood that a user who has not made a reservation will determine that the store 3A is crowded can decrease. Accordingly, it is possible to decrease the likelihood that a user who has not made a reservation for the store 3A stops entering the store 3A.

When it is determined that the degree of popularity of the store 3A is equal to or greater than the threshold value and it is determined that the length of the predicted staying time of the user A is less than the length of the reference staying time, the control unit 33 may determine that the user A is preferentially guided to a place with high visibility from the outside of the store 3A out of the places of the store 3A. The control unit 33 may estimate that a place in the store 3A has higher visibility from the outside of the store 3A as a distance from the doorway 4 which is an entrance of the store 3A or the window 5 becomes less. The control unit 33 can estimate that the places 6A to 6C out of the places of the store 3A have high visibility from the outside of the store 3A with reference to the place arrangement information of the store 3A in the storage unit 32. In this case, the control unit 33 can determine that the user A is preferentially guided to the places 6A to 6C. The control unit 33 can generate guidance information including information of the places 6A to 6C to which the user A is determined to be preferentially guided and the identification information of the user A. The control unit 33 can transmit the generated guidance information to the terminal device 20A of the store 3A.

In this way, when the degree of popularity of the store 3A is equal to or greater than the threshold value and thus the store 3A is estimated to be popular and when the length of the predicted staying time of the user A is less than the length of the reference staying time, the guidance information including the information of the places 6A to 6C can be transmitted to the terminal device 20A of the store 3A. In the terminal device 20A, the control unit 25 can output the guidance information from the output unit 23. By outputting the guidance information from the output unit 23, an employee B can recommend one of the places 6A to 6C to the user A when the user A visits the store 3A. When the employee B recommends one of the places 6A to 6C to the user A, the user A can sit in one of the places 6A to 6C. Here, when the length of the predicted staying time of the user A is less than the length of the reference staying time, another user may stay longer in the store 3A than the user A. When the user A sits in one of the places 6A to 6C, a likelihood that another user who may stay longer in the store 3A than the user A sits in one of the places 6A to 6C can decrease. Accordingly, when a user who has not made a reservation sees the inside of the store 3A through the doorway 4 or the window 5 as described above, a likelihood that a customer is sitting in the places 6A to 6C can decrease. When the length of the predicted staying time of the user A is less than the length of the reference staying time, the user A can leave the store 3A earlier than the other user even if the user A sits in one of the places 6A to 6C. Accordingly, when the user A sits in one of the places 6A to 6C and a user who has not made a reservation sees the inside of the store 3A through the doorway 4 or the window 5 as described above, a likelihood that the user A is sitting as a customer in the places 6A to 6C can decrease. Accordingly, when the likelihood that a customer is sitting in the places 6A to 6C decreases, a likelihood that a user who has not made a reservation will determine that the store 3A is crowded can decrease. Accordingly, it is possible to decrease the likelihood that a user who has not made a reservation for the store 3A stops entering the store 3A.

When it is determined that the degree of popularity of the store 3A is less than the threshold value, the control unit 33 may determine whether the length of the predicted staying time of the user A is equal to or greater than the length of the reference staying time.

When it is determined that the degree of popularity of the store 3A is less than the threshold value and it is determined that the length of the predicted staying time of the user A is equal to or greater than the length of the reference staying time, the control unit 33 may determine that the user A is preferentially guided to a place with high visibility from the outside of the store 3A out of the places of the store 3A. As described above, the control unit 33 may estimate that the places 6A to 6C out of the places of the store 3A have high visibility from the outside of the store 3A with reference to the place arrangement information of the store 3A in the storage unit 32. In this case, the control unit 33 can determine that the user A is preferentially guided to the places 6A to 6C. The control unit 33 can generate guidance information including information of the places 6A to 6C to which the user A is determined to be preferentially guided and the identification information of the user A. The control unit 33 can transmit the generated guidance information to the terminal device 20A of the store 3A.

In this way, when the degree of popularity of the store 3A is less than the threshold value and thus the store 3A is estimated to be less popular and when the length of the predicted staying time of the user A is equal to or greater than the length of the reference staying time, the guidance information including the information of the places 6A to 6C can be transmitted to the terminal device 20A of the store 3A. Accordingly, when the user A visits the store 3A, the user A can sit in one of the places 6A to 6C as described above. Here, when the degree of popularity of the store 3A is low, a user who has not made a reservation may ascertain whether the store 3A is prosperous by seeing the inside of the store 3A through the doorway 4 or the window 5 of the store 3A before entering the store 3A. In this case, when the user A with a long predicted staying time sits in one of the places 6A to 6C, a likelihood that the user A who is a customer is sitting in one of the places 6A to 6C when a user who has not made a reservation ascertains the inside of the store 3A can increase. When the likelihood that a customer is sitting in the places 6A to 6C increases, a likelihood that a user who has not made a reservation will determine that the store 3A is not prosperous can decrease. Accordingly, it is possible to decrease the likelihood that a user who has not made a reservation for the store 3A stops entering the store 3A.

When it is determined that the degree of popularity of the store 3A is less than the threshold value and it is determined that the length of the predicted staying time of the user A is less than the length of the reference staying time, the control unit 33 may determine that the user A is preferentially guided to a place with low visibility from the outside of the store 3A out of the places of the store 3A. As described above, the control unit 33 may estimate that the places 6G and 6H out of the places of the store 3A have low visibility from the outside of the store 3A with reference to the place arrangement information of the store 3A in the storage unit 32. The control unit 33 can determine that the user A is preferentially guided to the places 6G and 6H. The control unit 33 can generate guidance information including information of the places 6G and 6H to which the user A is determined to be preferentially guided and the identification information of the user A. The control unit 33 can transmit the generated guidance information to the terminal device 20A of the store 3A.

In this way, when the degree of popularity of the store 3A is less than the threshold value and thus the store 3A is estimated to be less popular and when the length of the predicted staying time of the user A is less than the length of the reference staying time, the guidance information including the information of the places 6G and 6H can be transmitted to the terminal device 20A of the store 3A. Accordingly, when the user A visits the store 3A, the user A can sit in the place 6G or 6H as described above. Here, when the length of the predicted staying time of the user A is less than the length of the reference staying time, another user may stay in the store 3A than the user A. When the user A sits in the place 6G or 6H, a likelihood that another user who may stay longer in the store 3A than the user A sits in one of the places 6A to 6C can increase. Accordingly, when a user who has not made a reservation sees the inside of the store 3A as described above, a likelihood that another user is sitting as a customer in the places 6A to 6C can increase. When the likelihood that a customer is sitting in the places 6A to 6C increases, a likelihood that a user who has not made a reservation will determine that the store 3A is not prosperous can decrease. Accordingly, it is possible to decrease the likelihood that a user who has not made a reservation for the store 3A stops entering the store 3A.

### Operation of Guidance System

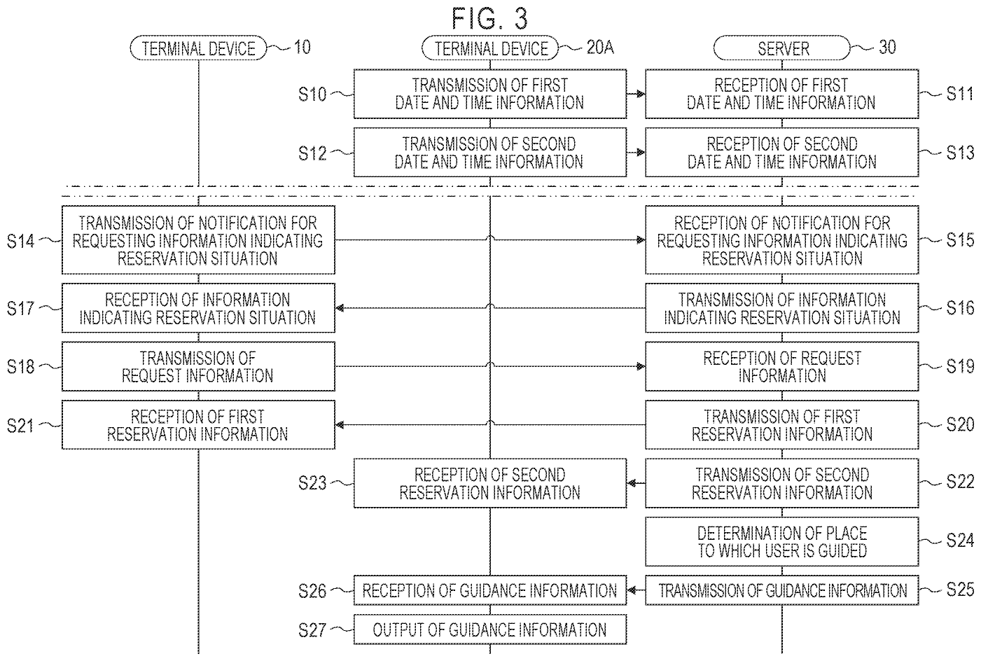

The operation of the guidance system 1 illustrated in FIG. 1 will be described below with reference to FIG. 3. This operation corresponds to an example of a guidance method according to this embodiment.

In the terminal device 20A, the control unit 25 transmits information of a first date and time along with the identification information of the store 3A and the identification information of the user A to the server 30 via the network 2 using the communication unit 21 (Step S10). In the server 30, the control unit 33 receives the information of the first date and time along with the identification information of the store 3A and the identification information of the user A from the terminal device 20A of the store 3A via the network 2 using the communication unit 31 (Step S11). In the terminal device 20A, the control unit 25 transmits information of a second date and time along with the identification information of the store 3A and the identification information of the user A to the server 30 via the network 2 using the communication unit 21 (Step S12). In the server 30, the control unit 33 receives the information of the second date and time along with the identification information of the store 3A and the identification information of the user A from the terminal device 20A of the store 3A via the network 2 using the communication unit 31 (Step S13).

In the terminal device 10, the control unit 15 transmits a notification for requesting information indicating a reservation situation of the store 3A to the server 30 via the network 2 using the communication unit 11 (Step S14). In the server 30, the control unit 33 receives a notification for requesting the information indicating the reservation situation of the store 3A from the terminal device 10 via the network 2 using the communication unit 11 (Step S15). In the server 30, the control unit 33 transmits the information indicating the reservation situation of the store 3A to the terminal device 10 via the network 2 using the communication unit 31 (Step S16). In the terminal device 10, the control unit 15 receives the information indicating the reservation situation of the store 3A from the server 30 via the network 2 using the communication unit 11 (Step S17).

In the terminal device 10, the control unit 15 transmits request information to the server 30 via the network 2 using the communication unit 11 (Step S18). In the server 30, the control unit 33 receives the request information from the terminal device 10 via the network 2 using the communication unit 31 (Step S19). When the request information is received, the control unit 33 can confirm the reservation of the user A. When the reservation of the user A for the store 3A is confirmed, the control unit 33 transmits first reservation information to the terminal device 10 via the network 2 using the communication unit 31 (Step S20). In the terminal device 10, the control unit 15 receives the first reservation information from the server 30 via the network 2 using the communication unit 11 (Step S21). In the server 30, the control unit 33 transmits second reservation information to the terminal device 20A of the store 3A via the network 2 using the communication unit 31 (Step S22). In the terminal device 20A, the control unit 25 receives the second reservation information from the server 30 via the network 2 using the communication unit 21 (Step S23).

In the server 30, when the reservation of the user A for the store 3A is confirmed, the control unit 33 determines a place to which the user A is guided out of the places of the store 3A (Step S24). The control unit 33 transmits guidance information including the information of the place to which the user A is guided to the terminal device 20A of the store 3A via the network 2 using the communication unit 31 (Step S25). In the terminal device 20A, the control unit 25 receives the guidance information from the server 30 via the network 2 using the communication unit 21 (Step S26). In the terminal device 20A, the control unit 25 outputs the guidance information from the output unit 23 (Step S27).

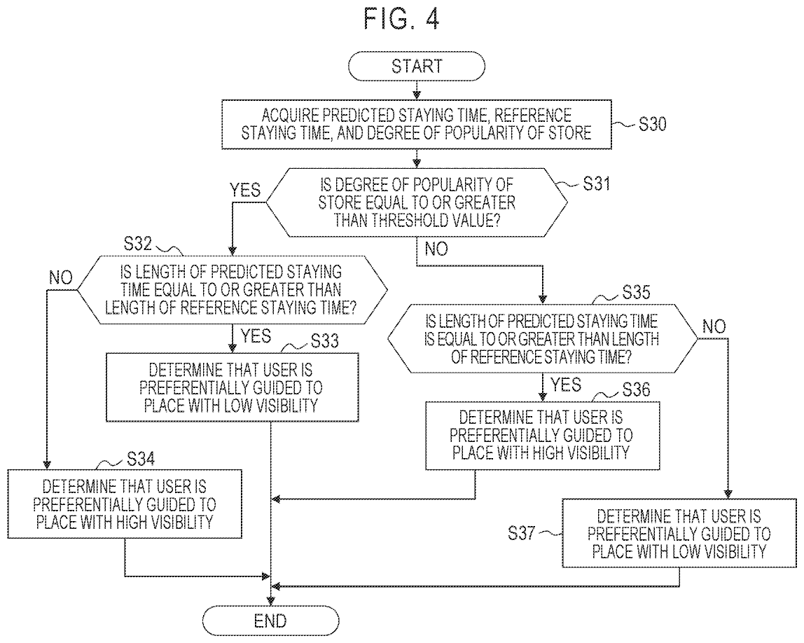

The operation of the server 30 illustrated in FIG. 1 will be described below with reference to FIG. 4. This operation corresponds to an example of the guidance method according to this embodiment. When a reservation of the user A for the store 3A is confirmed, the control unit 33 may start the flow of operations illustrated in FIG. 4.

The control unit 33 acquires a predicted staying time of the user A, a reference staying time, and a degree of popularity of the store 3A (Step S30). The control unit 33 determines whether the degree of popularity of the store 3A is equal to or greater than the threshold value (Step S31). When it is determined that the degree of popularity of the store 3A is equal to or greater than the threshold value (Step S31: YES), the control unit 33 causes the flow of operations to proceed to Step S32. On the other hand, when it is determined that the degree of popularity of the store 3A is less than the threshold value (Step S31: NO), the control unit 33 causes the flow of operations to proceed to Step S35.

In Step S32, the control unit 33 determines whether the length of the predicted staying time of the user A is equal to or greater than the length of the reference staying time. When it is determined that the length of the predicted staying time of the user A is equal to or greater than the length of the reference staying time (Step S32: YES), the control unit 33 determines that the user A is preferentially guided to a place with low visibility from the outside of the store 3A out of the places of the store 3A (Step S33). On the other hand, when it is determined that the length of the predicted staying time of the user A is less than the length of the reference staying time (Step S32: NO), the control unit 33 determines that the user A is preferentially guided to a place with high visibility from the outside of the store 3A out of the places of the store 3A (Step S34).

In Step S35, the control unit 33 determines whether the length of the predicted staying time of the user A is equal to or greater than the length of the reference staying time. When it is determined that the length of the predicted staying time of the user A is equal to or greater than the length of the reference staying time (Step S35: YES), the control unit 33 determines that the user A is preferentially guided to a place with high visibility from the outside of the store 3A out of the places of the store 3A (Step S36). On the other hand, when it is determined that the length of the predicted staying time of the user A is less than the length of the reference staying time (Step S35: NO), the control unit 33 determines that the user A is preferentially guided to a place with low visibility from the outside of the store 3A out of the places of the store 3A (Step S37).

In this way, the control unit 33 of the server 30 determines a place to which the user A is guided out of the places of the store 3A based on the result of comparison between the predicted staying time of the user A and the reference staying time. With this configuration, it is possible to decrease a likelihood that a user who has not made a reservation for the store 3A will stop entering the store 3A as described above. Accordingly, according to this embodiment, it is possible to improve availability information of the store 3A.

The disclosure is not limited to the aforementioned embodiment. For example, a plurality of blocks illustrated in the block diagram may be combined or a single block may be divided into two or more blocks. Instead of performing a plurality of steps illustrated in the flowchart in a time series as described above, the plurality of steps may be performed in parallel or in different order depending on processing capabilities of devices that perform the steps or depending on necessity. The aforementioned embodiment can be modified without departing from the gist of the disclosure.

In the aforementioned embodiment, the control unit 33 of the server 30 calculates the predicted staying time of the user A based on the average staying time in the past of the user A as the staying time in the past of the user A. That is, in the aforementioned embodiment, the control unit 33 calculates the predicted staying time of the user A based on an average value which is one of statistics acquired from the staying times in the past of the user A. However, the control unit 33 may calculate the predicted staying time of the user A based on any arbitrary statistics which can be acquired from the staying time in the past of the user A. For example, the control unit 33 may acquire the predicted staying time of the user A based on statistics such as a most frequent value or a median value of the staying times in the past of the user A.

For example, in the aforementioned embodiment, the control unit 33 of the server 30 acquires the predicted staying time of the user A in the store 3A based on the staying time in the past of the user A in the store 3A or the store 3B. However, the control unit 33 may acquire the predicted staying time of the user A in the store 3A using an arbitrary method. For example, the control unit 33 may receive image data from a camera which is installed at the home of the user A via the network 2 using the communication unit 31. The camera may be installed to image behavior of the user A at the home as a subject. For example, the camera is installed to image the user A eating at the home as a subject. The control unit 33 may identify behavior pattern indicating a pattern of the behavior of the user A at the home by analyzing the received image data. The control unit 33 may estimate the predicted staying time of the user A based on the identified behavior pattern of the user A and acquire the predicted staying time of the user A. For example, the control unit 33 estimates a time required for the user A to eat at the home based on the behavior pattern and estimates the predicted staying time of the user A based on the estimated time required for the user A to eat.

For example, in the aforementioned embodiment, the control unit 33 of the server 30 determines a place to which the user A is guided out of the places of the store 3A based on the degree of popularity of the store 3A and the result of comparison between the predicted staying time of the user A and the reference staying time. Determination of a place which is proposed for the user A is not limited to determination based on the degree of popularity of the store 3A and the result of comparison between the predicted staying time of the user A and the reference staying time. In the disclosure, the control unit 33 can determine a place which is proposed for the user A out of the places of the store 3A based on the result of comparison between the predicted staying time of the user A and the reference staying time. For example, when a user determines whether the user is to enter the store 3A or to stop entering the store 3A, the user may merely wonder whether the store 3A is crowded. In this case, the control unit 33 may determine the place to which the user A is guided out of the places of the store 3A based on a crowdedness rate of the store 3A and the result of comparison between the predicted staying time of the user A and the reference staying time. The control unit 33 may acquire an occupancy ratio of customers to the places of the store 3A as the crowdedness rate of the store 3A. The occupancy ratio of customers to the places of the store 3A may be calculated by dividing the number of places of the store 3A by the number of places in which customers sit. In this example, the control unit 33 may receive the crowdedness rate of the store 3A from the terminal device 20A of the store 3A via the network 2 using the communication unit 31 before a set time for the reserved time of the reservation date and time of the user A. The set time may be appropriately set based on variation of the crowdedness rate of the store 3A. When the crowdedness rate of the store 3A is equal to or greater than a crowdedness rate threshold value and the length of the predicted staying time of the user A is equal to or greater than the length of the reference staying time, the control unit 33 may determine that the user A is preferentially guided to the places 6G and 6H with low visibility from the outside of the store 3A out of the places of the store 3A. The crowdedness rate threshold value may be an index for determining whether a store 3 with a crowdedness rate equal to or greater than the crowdedness rate threshold value is more crowded than other stores. When the crowdedness rate of the store 3A is equal to or greater than the crowdedness rate threshold value and the length of the predicted staying time of the user A is less than the length of the reference staying time, the control unit 33 may determine that the user A is preferentially guided to the places 6A to 6C with high visibility from the outside of the store 3A out of the places of the store 3A. With this configuration, since the likelihood that a customer is sitting in the places 6A to 6C when a user ascertains the inside of the store 3A decreases, the likelihood that the user will determine that the store 3A is crowded can decrease. Accordingly, it is possible to decrease the likelihood that a user who merely wonders whether the store 3A is crowded will stop entering the store 3A. In this way, with the configuration in which a place to which the user A is guided is determined based on the crowdedness rate of the store 3A and the result of comparison between the predicted staying time of the user A and the reference staying time, it is also possible to improve availability information of the store 3A.

For example, in the aforementioned embodiment, the control unit 33 of the server 30 which is an information processing device determines a place to which the user A is guided out of the places of the store 3A. However, the information processing device that determines a place to which the user A is guided is not limited to the server 30. For example, the information processing device that determines a place to which the user A is guided may be the terminal device 20A of the store 3A. That is, the control unit 25 of the terminal device 20A which is an information processing device may determine a place to which the user A is guided out of the places of the store 3A by performing the same processes as in the control unit 33 of the server 30. In this case, the control unit 25 of the terminal device 20A may store the information of the first date and time and the information of the second date and time which are acquired as described above in the storage unit 24 in correlation with the identification information of the user A. The control unit 25 of the terminal device 20A may calculate the predicted staying time of the user A based on the staying time in the past of the user A in the store 3B similarly to the aforementioned embodiment. In this case, the control unit 25 of the terminal device 20A can receive the information of the first date and time and the information of the second date and time acquired by the terminal device 20B of the sore 3B along with the identification information of the user A from the terminal device 20B of the store 3B via the network 2 using the communication unit 21.

What is claimed is:

1. An information processing device comprising a control unit configured to acquire a predicted staying time in which a user is predicted to stay in a store and to determine a place to which the user is guided out of places of the store based on a result of comparison between the predicted staying time and a reference staying time.

2. The information processing device according to claim 1, wherein the control unit is configured to determine a place to which the user is guided out of the places of the store based on a degree of popularity of the store and the result of comparison.

3. The information processing device according to claim 2, wherein the control unit is configured to determine that the user is preferentially guided to a place with low visibility from the outside of the store out of the places of the store when it is determined that the degree of popularity is equal to or greater than a threshold value and it is determined that a length of the predicted staying time is equal to or greater than a length of the reference staying time.

4. The information processing device according to claim 3, wherein the control unit is configured to estimate that visibility of a place of the store from the outside of the store is lower as a distance from a doorway or a window of the store is greater.

5. The information processing device according to claim 2, wherein the control unit is configured to determine that the user is preferentially guided to a place with high visibility from the outside of the store out of the places of the store when it is determined that the degree of popularity is less than a threshold value and it is determined that the length of the predicted staying time is equal to or greater than the length of the reference staying time.

6. The information processing device according to claim 5, wherein the control unit is configured to estimate that visibility of a place of the store from the outside of the store becomes higher as a distance from a doorway or a window of the store becomes smaller.

7. The information processing device according to claim 2, wherein the control unit is configured to acquire the degree of popularity based on a reservation situation of the store.

8. The information processing device according to claim 2, further comprising a communication unit,
wherein the control unit is configured to acquire the degree of popularity based on information indicating evaluations of the store from users which is received from an external server using the communication unit.

9. The information processing device according to claim 1, wherein the control unit is configured to acquire the reference staying time by calculating an average staying time of a plurality of users who used the store in the past.

10. The information processing device according to claim 1, wherein the control unit is configured to determine a place to which the user is guided when a reservation of the user for the store is confirmed.

11. The information processing device according to claim 1, wherein the control unit is configured to calculate the predicted staying time based on a staying time of the user in the store in the past.

12. The information processing device according to claim 1, wherein the control unit is configured to calculate the predicted staying time based on a staying time of the user in the past in a store other than the store.

13. The information processing device according to claim 1, wherein the control unit is configured to correct the predicted staying time such that the predicted staying time is longer when the user is estimated to visit the store along with another user than when the user alone is estimated to visit the store.

14. The information processing device according to claim 1, wherein the control unit is configured to correct the predicted staying time according to the number of a plurality of other users when the user is estimated to visit the store along with the plurality of other users.

15. A guidance system comprising:
the information processing device according to claim 1; and
a terminal device that is provided in the store.

16. The guidance system according to claim 15, wherein the control unit of the information processing device is configured to transmit guidance information including information of a place to which the user is guided to the terminal device using the communication unit of the information processing device, and
wherein a control unit of the terminal device is configured to output the guidance information received from the information processing device by a communication unit of the terminal device from an output unit of the terminal device.

17. The guidance system according to claim 15, wherein a control unit of the terminal device is configured to acquire information of a first date and time at which the user has entered the store when an input indicating that the user has entered the store along with an input of identification information of the user is received by an input unit of the terminal device and to transmit the information of the first date and time along with the identification information of the user and the identification information of the store to the information processing device using a communication unit of the terminal device.

18. The guidance system according to claim 17, wherein the control unit of the terminal device is configured to acquire information of a second date and time at which the user has exited the store when an input indicating that the user has exited the store along with an input of the identification information of the user is received by the input unit of the terminal device and to transmit the information of the second date and time along with the identification information of the user and the identification information of the store to the information processing device using the communication unit of the terminal device.

19. The guidance system according to claim 18, wherein the control unit of the information processing device is configured to acquire a predicted staying time in which the user is predicted to stay in the store based on the information of the first date and time and the information of the second date and time received from the terminal device by the communication unit of the information processing device.

20. A guidance method comprising:
causing an information processing device to acquire a predicted staying time in which a user is predicted to stay in a store; and
causing the information processing device to determine a place to which the user is guided out of places of the store based on a result of comparison between the predicted staying time and a reference staying time.
